(19) United States
(12) Patent Application Publication
(10) Pub. No.: US 2024/0400040 A1
(43) Pub. Date: Dec. 5, 2024

(54) REDUCING THE DANGER OF AN ICY HOLLOW FORMING BELOW TIRES OF A VEHICLE

(71) Applicant: DAIMLER TRUCK AG, Leinfelden-Echterdingen (DE)

(72) Inventors: Fridtjof STEIN, Ostfildern (DE); Chaitra Ashok REDDY, Asperg (DE); Carlo ELWINGER, Maulbronn (DE)

(21) Appl. No.: 18/676,835

(22) Filed: May 29, 2024

(30) Foreign Application Priority Data
May 30, 2023 (DE) 10 2023 114 049.3

(51) Int. Cl. B60W 30/06; B60W 60/00

(52) U.S. Cl. CPC B60W 30/06; B60W 60/0015; B60W 2300/145; B60W 2420/403; B60W 2555/20

(57) ABSTRACT

A vehicle system is configured to determine the danger of an icy hollow forming below tires of the vehicle parked or yet to be parked on a ground by detecting ice and snow on the ground and by ascertaining a surroundings temperature, and when the danger of an icy hollow forming is recognized, to ascertain a second parking place different to an original parking place of the vehicle depending on at least one spacing between a first axle and a second axle, such that the position of the second axle on the second parking place of the vehicle is not the same as the position of the first axle on the original parking place of the vehicle.

### CROSS-REFERENCE TO RELATED APPLICATIONS

This application claims priority under 35 U.S.C. § 119 to German application number 10 2023 114 049.3, filed May 30, 2023, the entire disclosure of which is herein expressly incorporated by reference.

### BACKGROUND AND SUMMARY OF THE INVENTION

Exemplary embodiments of the invention relate to a system for a vehicle equipped with a driving control unit for automatic vehicle control for reducing the danger an icy hollow forming below tires of the vehicle, and a vehicle having such a system.

Heavy vehicles, in particular lorries or busses, can, when parking on snow or ice, be affected by reduced friction, in particular. Difficulties due to reduced friction on a frozen surface when driving away can occur, in particular, when such a heavy vehicle with warmed tires due to a previous longer journey on snow or ice is parked. Under certain temperature conditions it can occur, in particular, that the heated tires cause the contacting ice or snow to melt locally, however if the vehicle is parked for a long time, the ice or snow that has melted into liquid water freezes back into ice after the tires have cooled down, and an icy hollow forms around the tires. When the vehicle drives away, such an icy hollow can act particularly disruptively since, on the one hand, the friction between tires and the icy surface of the hollow is very minimal, and moreover the shape of the hollow means that the vehicle has to overcome an incline at least for a short way, which, due to the low friction of the ice, however, can be insurmountable for the vehicle. To do so, the deadweight of the vehicle also contributes, which can be particularly high with lorries or buses or other heavy vehicles; compressed snow and ice itself can creep i.e., slowly deform; this can contribute to the icy hollow, which forms under the respective tire of the vehicle, becoming even deeper and thus further exacerbating the vehicle driving away.

In the prior art, the problem of reduced friction coefficients and slopes, in particular in combination with each other, has already been addressed. In this context, US 2021/0247769 A1 is concerned with a vehicle, on which an autonomous driving system can be mounted, comprising: a vehicle platform, which controls the vehicle according to an instruction of the autonomous driving system; and a vehicle control interface, which constitutes interfaces between the vehicle platform and the autonomous driving system, wherein the vehicle control interface provides a signal to the autonomous driving system, the signal displaying a movement direction of the vehicle, which is determined by means of a majority rule in conjunction with rotational directions of wheels. In an embodiment of US 2021/0247769 A1 when a specific period of time has elapsed when a speed of all vehicles is zero, the vehicle control interface provides a signal to the autonomous driving system, the signal displaying “standstill” as the signal, which displays the movement direction of the vehicle. Depending on the configuration, after a certain period of time has elapsed in which the speed of all wheels is zero, a corresponding signal for displaying the stop (the signal “standstill”) can be provided to the autonomous driving system.

Moreover, in the prior art, methods are demonstrated with which a vehicle that is already stuck can leave its location and get clear again:

For this, US 2019/0111932 A1 relates to a method, consisting of the following steps: generating a map with obstacles and a predicted friction coefficient between vehicle wheels and a roadway surrounding a stuck vehicle based on sensor data; determining a path based on the map; and operating the stuck vehicle based on the track and a slippage control process based on the vehicle wheels.

Sending a request for help is also known in the prior art in order to request remote support:

For this, US 2015/0248131 A1 relates to a computer-implemented method which comprises the following: determining a depiction of the surroundings of an autonomous vehicle based on senor data of the surroundings; based on the depiction, a situation from a predetermined sequence, identifying situations for which the autonomous vehicle requests remote support; sending a request for help to a remote assistant, wherein the request comprises the depiction of the surroundings and the ascertained situation; receiving an answer from the remote assistant which indicates an autonomous process; and inducing an autonomous operation of the autonomous vehicle.

The general topic of reduced friction is addressed in the following publication, which determines a road state and a road friction coefficient predicted on the basis of this, in particular by means of an image.

KR 20220007970 A relates to a division/prediction of a roadway friction coefficient into finer regions and the use of information for the autonomous control, such that the driving state of an autonomous vehicle can also be safely maintained in poor weather with rain or snow. According to an embodiment, the method comprises a step of using an image and predicting a road state; a step of predicting a road friction coefficient based on the predicted road state; a step of generating a piece of braking control information when braking is required during the journey; and a step of correcting the generated braking control information by using the predicted road friction coefficient. Correspondingly, it is possible to predict a degree of road friction.

While the request for help or means for releasing an already stuck vehicle constitutes reactions to the situation of gridlock that has already occurred, it is desirable to prevent getting stuck in the first place. Exemplary embodiments of the present invention are therefore directed to a system that helps to avoid a vehicle getting stuck, in particular a heavy vehicle such as a lorry or a bus.

A first aspect of the invention relates to a system for a vehicle, in particular a lorry, equipped with a driving control unit for automatic vehicle control, wherein the system is set up to ascertain a danger of an icy hollow forming below tires of the vehicle parked or yet to be parked on a ground by detecting ice and/or snow on the ground and by ascertaining an air temperature and/or a temperature of the ground, and when a danger of an icy hollow forming is recognized, ascertaining a second parking place different to an original parking place of the vehicle depending on at least one spacing between a first axle and a second axle of the vehicle, such that the position of the second axle (position relative to the ground) on the second parking place of the vehicle is not the same as the position (position relative to the ground) of the first axle on the original parking place, and wherein the system is set up to command the driving control unit of the vehicle to occupy the second parking place of the vehicle after a predetermined period of time after occupying the original parking place.

In principle, the second parking place of the vehicle could be chosen to be opposite the main driving direction of the original parking place of the vehicle. However, in particular with lorries, driving backwards is unwanted and to be avoided as far as possible, since the danger of a collision with an obstacle or a person thus increases and is considerably higher than when driving forwards. If it is accordingly assumed that the second parking place of the vehicle is chosen in front of the original parking place of the vehicle in the main driving direction of the vehicle, then the position of the first considered axle is advantageously in front of the position of the second axle which is considered. Advantageously, it is thus prevented that the wheels of a further axle drive into an icy hollow of a different axle already emerging from the start, and this icy hollow correspondingly deepens. Depending on the number of axles of the vehicle, not only the wheels and tires are here to be considered, but rather advantageously all (at least the driven) axles of the vehicle in pairs in relation to each other, for which a paired common occupation of a location on the ground starting from the original parking place to the second parking place is taken into consideration.

Occupying a second parking place opposite the original parking place can be repeated in any number of iterations, such that a third and a fourth parking place are occupied after respective predetermined periods of time. The method of the system described above and below can here be respectively applied without change to the various pairs of parking places, wherein the respective original parking place is a respectively currently parking place, and the respective second parking place is a parking place changed in relation to this original parking place, such that the terms of the original parking place and the second parking place can be relative terms in pairs of parking places. The repetition preferably takes place so long as a difference of a current tire temperature and a current surroundings temperature (or alternatively a temperature of the ground) does not meet a predetermined fifth threshold value.

The vehicle is equipped with a driving control unit, which is set up to move and to steer the vehicle even without a human driver, i.e., to carry out the complete vehicle control of the vehicle and accordingly to also move the vehicle automatically, which has been parked on the original parking place, to the second parking place.

Determining the air temperature can be carried out with a thermometer arranged on the vehicle, yet can also be taken from a central database with its current value, in particular by means of a digital map and the current position of the vehicle. The temperature of the ground can also be determined via corresponding model calculations, information from central databases and corresponding position information of the vehicle, can also, in principle, also be ascertained directly by a radiation thermometer, which is arranged on the vehicle, in order to ascertain a respectively current temperature of the ground based on the heat radiation of the ground. In rare cases, weather phenomena, in particular, can occur, in which the air temperature is considerably higher or considerably lower than the temperature of the ground. In order to be able to take such weather phenomena into consideration, the temperature of the ground and the air temperature are advantageously ascertained and, by combining the two, the danger of an icy hollow forming is determined.

Furthermore, a likely downtime at the original parking place is advantageously determined and a weather prediction is advantageously taken into consideration by the system. If the original parking place is at the end of a traffic jam on a motorway, then a spontaneous re-movement of the vehicle is to be assumed and thus only the current air temperature or the current temperature of the ground is advantageously to be taken into consideration. However, should the vehicle remain for several days on the original parking place, for example, then the weather prediction can be helpful in order to predict the danger of an icy hollow forming.

Thus, an advantageous effect of the invention is that the danger of an icy hollow forming is reduced, and when it begins to form at the original parking place, the vehicle does not remain there too long, such that it is not yet so deep that the vehicle would not be able to free itself from this icy hollow using its own power. By shifting the vehicle from the original parking place to the second parking place, the initial cooling of the tires in the cold air and on the cold ground is used in order to be able to drive to and occupy the second parking place with tires that have already cooled down. The formation a further icy hollow on the second parking place is thus significantly lower, wherein, with further existing danger of an icy hollow forming at the second parking place that is also too deep, the method can be repeated by the system, and the vehicle can be shifted again. The danger of the vehicle being trapped in an icy hollow after remaining at the original parking place for too long a period of time is thus advantageously considerably reduced by the method carried out by the system.

According to an advantageous embodiment, the system is set up to only recognize a danger of an icy hollow forming when the temporal length of a previous journey of the vehicle exceeds a predetermined first threshold value, and/or when a current tire temperature ascertained by means of a tire temperature sensor unit of the system exceeds a predetermined second threshold value when occupying the original parking place.

The tire temperature sensor unit is advantageously an infrared camera, which is designed to ascertain heat radiation and to ascertain a current temperature of at least one tire based on the intensity and/or frequencies of the heat radiation irradiated by the tires. If, by contrast, no temperature sensors for determining the temperature of at least one of the tires are present, then heuristics can also be used, which predict, in particular from the loading of the vehicle, the time duration of the immediately preceding journey of the vehicle, and the surroundings temperature and/or the temperature of the ground, a temperature or a temporal temperature course of one or more tires of the vehicle.

According to a further advantageous embodiment, the system is set up to only recognize the danger of an icy hollow forming when the air temperature and/or the temperature of the ground lies below a predetermined third threshold value.

The third predetermined threshold value is preferably freezing point, namely 0° C., further preferably −2° C.

According to a further advantageous embodiment, the system is designed to determine the second parking place depending on at least one spacing between two driven axles of the vehicle, such that the position of the second driven axle at the second parking place of the vehicle is not the same as the position of the first driven axle at the original parking place of the vehicle.

According to a further advantageous embodiment, the system is designed to determine the second parking place depending on the respective paired spacing between all axles of the vehicle that are taken into account for a potential overlap of the positions of the tires belonging to the axles on the ground between the original and the second parking place.

According to a further advantageous embodiment, the system has a camera for recording a ground in the surroundings of the vehicle, and is set up to carry out an image recognition based on the data of the camera and to recognize ice and/or snow on the ground.

According to a further advantageous embodiment, the system is set up to recognize the danger of an icy hollow forming based on a heuristic correlation comprising at least one air temperature and/or one temperature of the ground and has a probability of the danger of an icy hollow forming as the starting value, wherein the danger of an icy hollow forming is recognized when exceeding the probability above a predetermined fourth threshold value.

According to a further advantageous embodiment, the system is set up to already determine the original parking place in such a way that sufficient shunting length remains in front of the vehicle, in order to be able to occupy the ascertained second parking place of the vehicle.

This thus includes recognizing a traffic jam, for example on a motorway, and, when this is recognized, the system prompts the vehicle to occupy a parking place in front of the traffic jam with sufficient spacing to the end of the traffic jam, such that the vehicle has sufficient spacing to the traffic jam in the given driving direction on the road or the roadway driven on by the vehicle, in order to be able to occupy the second parking place as ascertained.

According to a further advantageous embodiment, the system is designed to determine the predetermined period of time for occupying the second parking place of the vehicle after occupying the original parking place depending at least on the ascertained air temperature and/or the temperature of the ground.

Furthermore, the current tire temperature and/or the duration of the previous journey and/or an average speed in the previous journey and/or a loading state of the vehicle and/or the total mass of the vehicle can be taken into consideration by the system. Thus, the same parameters used for determining the danger of an icy hollow forming can also be drawn on to ascertain the period of time after which the vehicle is moved into the second parking place since the point in time of occupying the original parking place of the vehicle.

Furthermore, the system is preferably set up to also determine this predetermined period of time depending on a current tire temperature and/or the period of time of an immediately preceding journey of the vehicle. Thus, the speed is advantageously taken into consideration with which the formation of such an icy hollow could take place. In particular, the warmer the tires are, the more quickly the vehicle sinks with its tires into the frozen surface (in snow or ice); in contrast, the lower the temperature of the ground and the temperature of the surroundings air, the more quickly a cooling of the tires takes place and the more quickly the melted water re-freezes in the form of a frozen and thus icy hollow.

A further aspect of the invention relates to a vehicle having a system as described above and below.

Advantages and preferred developments of the proposed vehicle emerge from an analogous and corresponding transfer of the designs made above in the context of the proposed system.

Further advantages, features and details emerge from the description below in which, optionally with reference to the drawings, at least one exemplary embodiment is described in detail. The same, similar and/or functionally identical parts are provided with the same reference numerals.

### BRIEF DESCRIPTION OF THE DRAWING FIGURES

Here are shown:

FIGS. 1A-1F illustrate a system for reducing the danger of an icy hollow forming below tires of a vehicle according to an exemplary embodiment of the invention.

The depictions in the Figure are schematic and not to scale.

### DETAILED DESCRIPTION

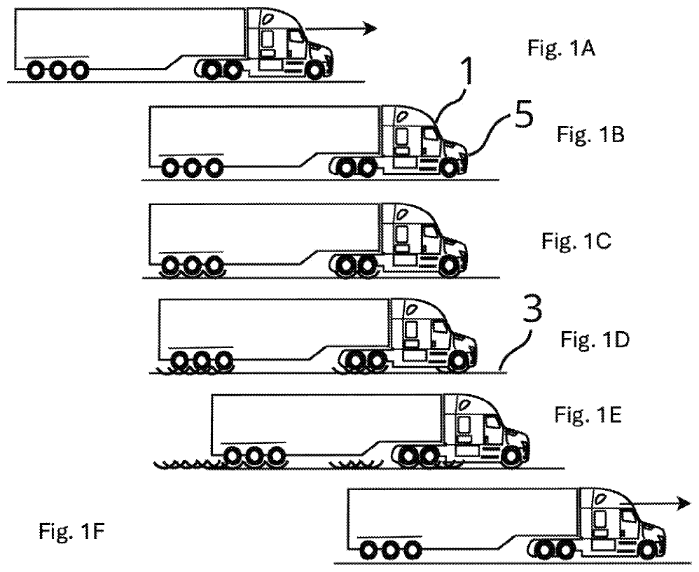

FIGS. 1A-F show a lorry as the vehicle 1 over the points in time A to F, wherein the lorry 1 has a driving control unit for automatically driving the vehicle. Firstly, the system checks whether there is generally the danger of an icy hollow forming below tires of the lorry 1 parked or yet to be parked on a ground 3. For this, even during the approach in step (A) (FIG. 1A), the system uses a camera 5, which is directed onto the ground in the immediate surroundings of the lorry 1. By implementing a first artificial neuronal network onto the image data of the camera 5, it is checked by means of image recognition as to whether ice and/or snow is present to a significant extent on the ground. If this is the case, then generally a potential danger of an icy hollow forming below the tires of the lorry 1 is assumed when it is parked on this ice or the snow. Furthermore, the system determines a current air temperature, a current temperature of the ground 3 and a current temperature of at least one of the tires of the lorry 1. By implementing a second artificial neuronal network based on all determined temperature ratios between the air, ground and tires and, optionally, a prediction of the thickness of the ice or the snow on the ground, a probability of an icy hollow forming below the respective tire of the lorry 1 is ascertained. If this probability exceeds a predetermined threshold value, a period of time is determined by the system that is deemed safe for leaving the lorry 1 on its original parking place. After this period of time, a driving control unit of the lorry 1 is commanded by the system in such a way that the lorry 1 is automatically moved from its original parking place to a second parking place. Within this period of time, i.e., before the movement to the second parking place, the initial formation of an icy hollow is already carried out at the original parking place in partial image (FIG. 1B), as outlined in partial image (FIG. 1C). Such icy hollows begin to form below all wheels underneath the tire surface of the lorry 1.

The second parking place of the lorry 1 is here determined by the system in such a way that it lies in front of the original parking place in the main driving direction of the lorry 1, namely in such a way that none of wheels having the tires come to rest in a position on the second parking place of the vehicle 1, at which, at the original parking place of the lorry 1, a different tire of a wheel of the lorry 1 has already come to rest. This can be seen in partial image (FIG. 1D), according to which the lorry 1 is driven by half the spacing between two adjacent axles of the articulated lorry trailer and the prime mover from the original position at the original parking place towards the second parking place. After a further period of time, the process is repeated, and the lorry 1 moves once again over the ground 3 by an even greater distance, such that the lorry 1 touches the ground 3 with its tires on positions which have not been touched by the tires on the first two original parking places. The result can be seen in partial image (FIG. 1E). The lorry 1 is thus parked at the final second parking place on a position of the ground 3 at which it has been parked with virtually completely cooled tires. It is thus easily possible for the lorry 1 to drive off (FIG. 1F), since only the weight has somewhat compromised the frozen ground 3, an additional warmth of the wheels and tires of the lorry 1 was, however, hardly still present and thus has not contributed to the formation of an icy hollow below each of the tires.

Although the invention has been illustrated and explained in more detail by preferred exemplary embodiments, the invention is not limited by the disclosed examples, and other variations can be derived by a person skilled in the art from this, without leaving the protected scope of the invention. It is thus clear that a plurality of variation possibilities exists. It is also clear that embodiments mentioned by way of example only really constitute examples, which are not to be understood in any way as limiting the protected scope, for example, the application possibilities or the configuration of the invention. Instead, the previous description and the description of the figures allow the person skilled in the art to concretely implement the exemplary embodiments, wherein, with an understanding of the disclosed idea of the invention, the person skilled in the art can implement various amendments, for example with respect to the function or the arrangement of individual elements mentioned in an exemplary embodiment, without leaving the protected scope which is defined by the claims and their legal equivalences, such as further explanations in the description, for example.

What is claimed is:

1. A system for a vehicle equipped with a driving control unit configured to automatically control the vehicle, wherein the system is configured to:
determine a danger of an icy hollow forming below tires of the vehicle parked or yet to be parked on a ground by detecting ice or snow on the ground and by determining an air temperature or a temperature of the ground,
determining, responsive to determining there is the danger of the icy hollow forming, a second parking place different from an original parking place of the vehicle depending on at least one spacing between a first axle and a second axle of the vehicle such that a position of the second axle on the second parking place of the vehicle is not same as a position of the first axle on the original parking place of the vehicle, and
commanding the driving control unit of the vehicle to occupy the second parking place of the vehicle after a predetermined period of time after occupying the original parking place,
wherein the vehicle is a lorry.

2. The system of claim 1, wherein the system is further configured to:
recognize the danger of the icy hollow forming only when a temporal length of a previous journey of the vehicle exceeds a predetermined first threshold value or when a current tire temperature determined by a tire temperature sensor unit of the system exceeds a predetermined second threshold value when occupying the original parking place.

3. The system of claim 1, wherein the system is configured to:
recognize the danger of the icy hollow forming only when the air temperature or the temperature of the ground is below a predetermined third threshold value.

4. The system of claim 1, wherein the system is configured to:
determine the second parking place depending on at least one spacing of two driven axles of the vehicle such that the position of the second driven axle on the second parking place of the vehicle is not same as the position of the first driven axle on the original parking place of the vehicle.

5. The system of claim 1, wherein the system is configured to:
determine the second parking place depending on respective paired spacing of all axles of the vehicle taken into account for a potential overlap of positions of tires belonging to the axles on the ground between the original and second parking place.

6. The system of claim 1, wherein the system has a camera configured to record the ground in surroundings of the vehicle, and the system is configured to perform image recognition based on data of the camera and to recognize ice or snow on the ground.

7. The system of claim 1, wherein the system is configured to recognize the danger of the icy hollow forming based on a heuristic correlation, which comprises at least one air temperature or a temperature of the ground and has a probability of the danger of the icy hollow forming as the starting value, wherein the danger of the icy hollow forming is recognized when the probability exceeds a predetermined fourth threshold value.

8. The system of claim 1, wherein the system is configured to predetermine the original parking place in such a way that there is sufficient shunting length in front of the vehicle to be able to occupy the determined second parking place of the vehicle.

9. The system of claim 1, wherein the system is configured to determine the predetermined period of time for occupying the second parking place of the vehicle after occupying the original parking place at least depending on the determined air temperature or the temperature of the ground.

10. A vehicle, comprising:
a driving control unit configured to automatically control the vehicle; and
a system configured to
determine a danger of an icy hollow forming below tires of the vehicle parked or yet to be parked on a ground by detecting ice or snow on the ground and by determining an air temperature or a temperature of the ground,
determining, responsive to determining there is the danger of the icy hollow forming, a second parking place different from an original parking place of the vehicle depending on at least one spacing between a first axle and a second axle of the vehicle such that a position of the second axle on the second parking place of the vehicle is not same as a position of the first axle on the original parking place of the vehicle, and
commanding the driving control unit of the vehicle to occupy the second parking place of the vehicle after a predetermined period of time after occupying the original parking place,
wherein the vehicle is a lorry.

11. A method for operating a vehicle, the method comprising:
determine a danger of an icy hollow forming below tires of the vehicle parked or yet to be parked on a ground by detecting ice or snow on the ground and by determining an air temperature or a temperature of the ground,
determining, responsive to determining there is the danger of the icy hollow forming, a second parking place different from an original parking place of the vehicle depending on at least one spacing between a first axle and a second axle of the vehicle such that a position of the second axle on the second parking place of the vehicle is not same as a position of the first axle on the original parking place of the vehicle, and
automatically moving the vehicle to occupy the second parking place of the vehicle after a predetermined period of time after occupying the original parking place,
wherein the vehicle is a lorry.

12. The method of claim 11, wherein the danger of the icy hollow forming is recognized only when a temporal length of a previous journey of the vehicle exceeds a predetermined first threshold value or when a current tire temperature determined by a tire temperature sensor unit of the system exceeds a predetermined second threshold value when occupying the original parking place.

13. The method of claim 11, wherein the danger of the icy hollow forming is recognized only when the air temperature or the temperature of the ground is below a predetermined third threshold value.

14. The method of claim 11, wherein the second parking place is determined depending on at least one spacing of two driven axles of the vehicle such that the position of the second driven axle on the second parking place of the vehicle is not same as the position of the first driven axle on the original parking place of the vehicle.

15. The method of claim 11, wherein the second parking place is determined depending on respective paired spacing of all axles of the vehicle taken into account for a potential overlap of positions of tires belonging to the axles on the ground between the original and second parking place.

16. The method of claim 11, wherein the vehicle has a camera configured to record the ground in surroundings of the vehicle, and wherein image recognition is performed based on data of the camera to recognize ice or snow on the ground.

17. The method of claim 11, wherein the danger of the icy hollow forming is recognized based on a heuristic correlation, which comprises at least one air temperature or a temperature of the ground and has a probability of the danger of the icy hollow forming as the starting value, wherein the danger of the icy hollow forming is recognized when the probability exceeds a predetermined fourth threshold value.

18. The method of claim 11, wherein the original parking place is predetermined in such a way that there is sufficient shunting length in front of the vehicle to be able to occupy the determined second parking place of the vehicle.

19. The method of claim 11, wherein the predetermined period of time for occupying the second parking place of the vehicle after occupying the original parking place is determined at least depending on the determined air temperature or the temperature of the ground.
